(19) United States
(12) Patent Application Publication
(10) Pub. No.: US 2008/0005512 A1
(43) Pub. Date: Jan. 3, 2008

(54) Network performance in virtualized environments

(76) Inventors: Raja Narayanasamy, Hillsboro, OR (US); Sujoy Sen, Portland, OR (US); Dharmin Y. Parikh, Queen Creek, AZ (US)

Correspondence Address: Caven & Aghevli LLC;c/o Intellevate, P.O. Box 52050, Minneapolis, MN, 55402, US

(21) Appl. No.: 11/478,423

(22) Filed: Jun. 29, 2006

(51) Int. Cl. G06F 12/14; G06F 12/00

(52) U.S. Cl. 711/163; 711/207

(57) ABSTRACT

Methods and apparatus to provide improved network input/output (I/O) performance in virtualized environments are described. In one embodiment, one or more entries of an I/O cache (e.g., a translation lookaside buffer) are locked in response to a request to lock the one or more entries. Other embodiments are also described.

### BACKGROUND

The present disclosure generally relates to the field of electronics. More particularly, an embodiment of the invention relates to a locking mechanism that improves network input/output (I/O) performance in virtualized environments.

Computer networks have become an integral part of computing. To improve networking bandwidth, some systems may utilize virtualization. For example, virtual memory addressing may allow for access to a relatively larger amount of storage. However, virtualized environments may limit full utilization of advances in networking bandwidth, e.g., due to overhead associated with translating between virtual and physical addresses.

### BRIEF DESCRIPTION OF THE DRAWINGS

The detailed description is provided with reference to the accompanying figures. In the figures, the left-most digit(s) of a reference number identifies the figure in which the reference number first appears. The use of the same reference numbers in different figures indicates similar or identical items.

FIG. 1 illustrates various components of an embodiment of a networking environment, which may be utilized to implement various embodiments discussed herein.

FIGS. 2 and 5 illustrate block diagrams of embodiments of computing systems, which may be utilized to implement various embodiments discussed herein.

FIG. 3 illustrates a block diagram of portions of an input/output translation lookaside buffer, according to an embodiment

FIG. 4 illustrates a flow diagram of a method to cause locking of one or more entries in a translation lookaside buffer, according to an embodiment.

### DETAILED DESCRIPTION

In the following description, numerous specific details are set forth in order to provide a thorough understanding of various embodiments. However, various embodiments of the invention may be practiced without the specific details. In other instances, well-known methods, procedures, components, and circuits have not been described in detail so as not to obscure the particular embodiments of the invention.

Some of the embodiments discussed herein may provide an efficient mechanism for improving network I/O performance in virtualized environments, e.g., by reducing address translation latency and/or packet drops. In an embodiment, one or more entries in an I/O cache (such as a translation lookaside buffer (TLB)) used for translating between physical and virtual addresses may be locked. Locking of entries may reduce the occurrence of misses in an I/O cache which in turn may improve networking I/O performance for subsequent access to the cached address translation data.

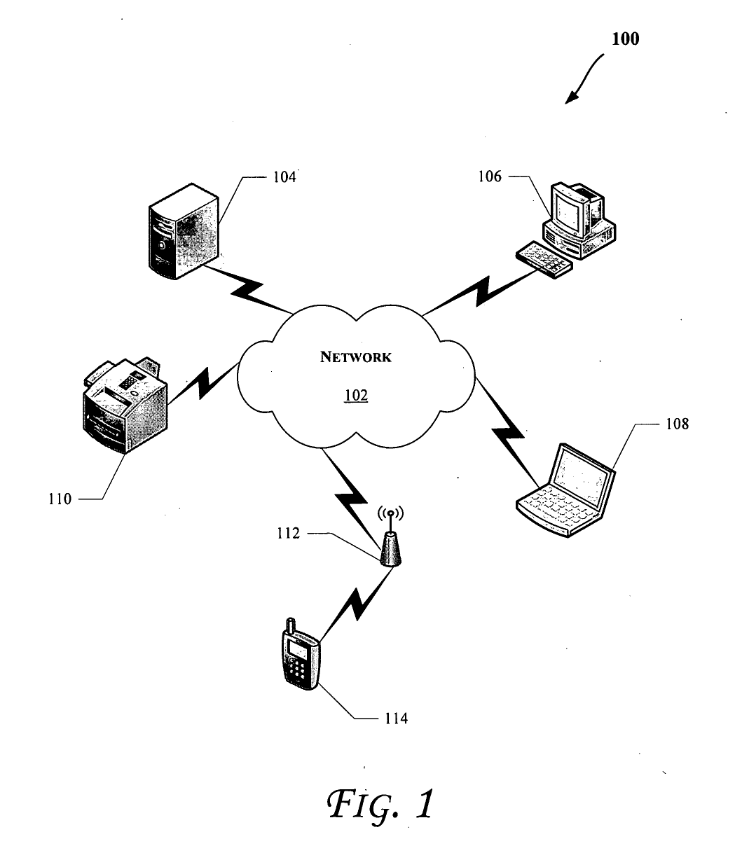

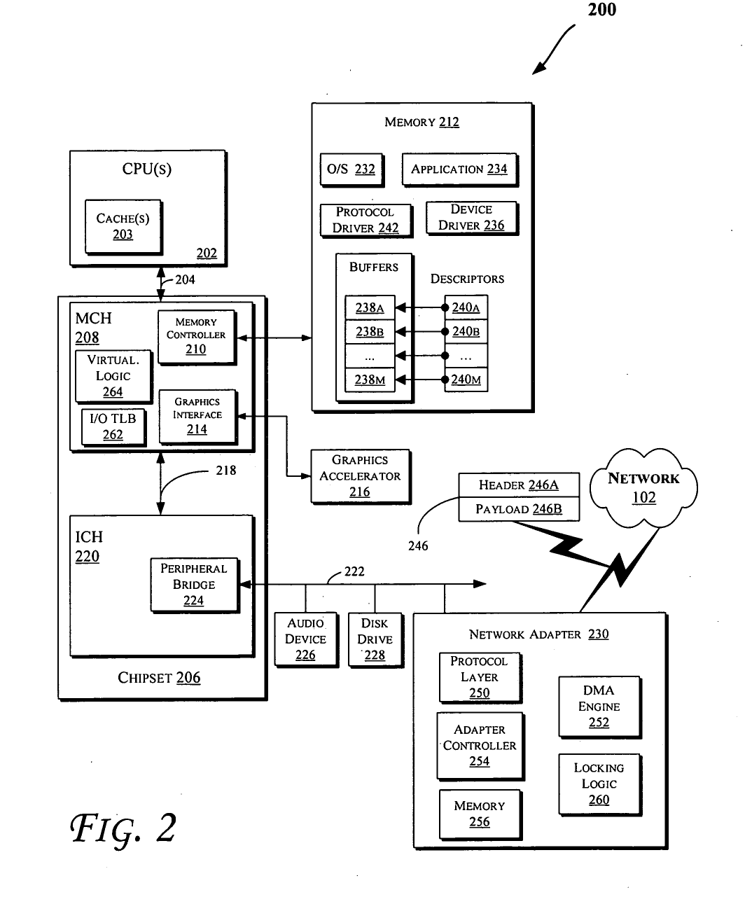

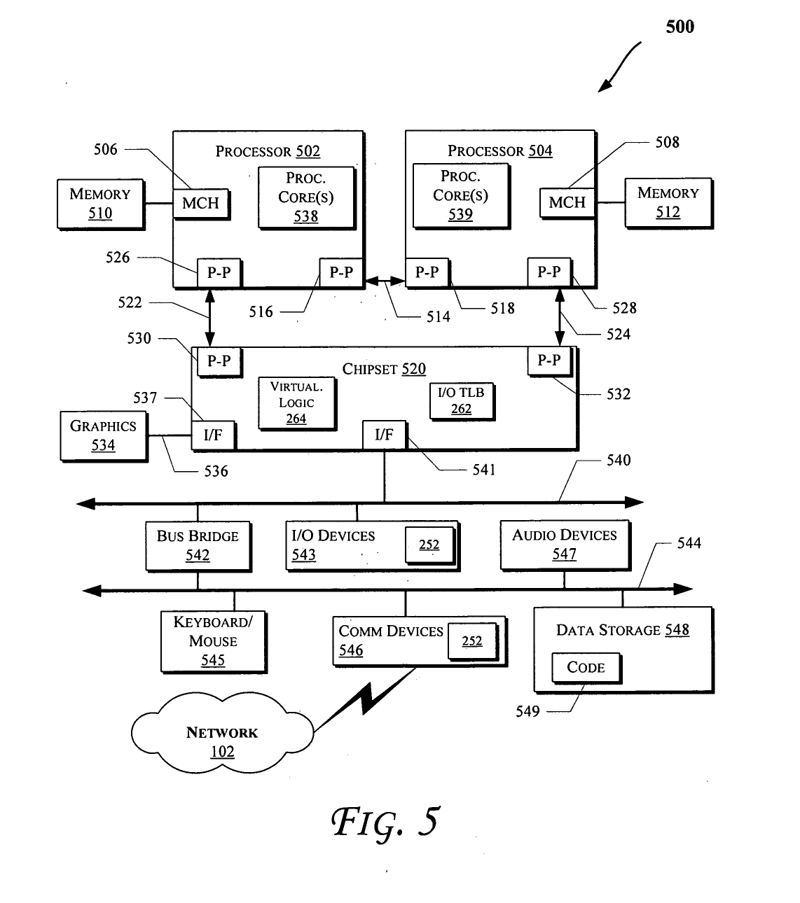

Furthermore, some of the embodiments discussed herein may be applied in various environments, such as the networking environment discussed with reference to FIG. 1 and/or the computing systems discussed with reference to FIGS. 2 and 5. More particularly, FIG. 1 illustrates various components of an embodiment of a networking environment 100, which may be utilized to implement various embodiments discussed herein. The environment 100 may include a network 102 to enable communication between various devices such as a server computer 104, a desktop computer 106 (e.g., a workstation or a desktop computer), a laptop (or notebook) computer 108, a reproduction device 110 (e.g., a network printer, copier, facsimile, scanner, all-in-one device, etc.), a wireless access point 112, a personal digital assistant or smart phone 114, a rack-mounted computing system (not shown), etc. The network 102 may be any type of type of a computer network including an intranet, the Internet, and/or combinations thereof.

The devices 104-114 may communicate with the network 102 through wired and/or wireless connections. Hence, the network 102 may be a wired and/or wireless network. For example, as illustrated in FIG. 1, the wireless access point 112 may be coupled to the network 102 to enable other wireless-capable devices (such as the device 114) to communicate with the network 102. In one embodiment, the wireless access point 112 may include traffic management capabilities. Also, data communicated between the devices 104-114 may be encrypted (or cryptographically secured), e.g., to limit unauthorized access.

The network 102 may utilize any communication protocol such as Ethernet, Fast Ethernet, Gigabit Ethernet, wide-area network (WAN), fiber distributed data interface (FDDI), Token Ring, leased line, analog modem, digital subscriber line (DSL and its varieties such as high bit-rate DSL (HDSL), integrated services digital network DSL (IDSL), etc.), asynchronous transfer mode (ATM), cable modem, and/or FireWire.

Wireless communication through the network 102 may be in accordance with one or more of the following: wireless local area network (WLAN), wireless wide area network (WWAN), code division multiple access (CDMA) cellular radiotelephone communication systems, global system for mobile communications (GSM) cellular radiotelephone systems, North American Digital Cellular (NADC) cellular radiotelephone systems, time division multiple access (TDMA) systems, extended TDMA (E-TDMA) cellular radiotelephone systems, third generation partnership project (3G) systems such as wide-band CDMA (WCDMA), etc. Moreover, network communication may be established by internal network interface devices (e.g., present within the same physical enclosure as a computing system) such as a network interface card (NIC) or external network interface devices (e.g., having a separate physical enclosure and/or power supply than the computing system to which it is coupled).

FIG. 2 illustrates a block diagram of an embodiment of a computing system 200. One or more of the devices 104-114 discussed with reference to FIG. 1 may comprise the computing system 200. The computing system 200 may include one or more central processing unit(s) (CPUs) 202 (which may be collectively referred to herein as “processors 202” or “processor 202”) coupled to an interconnection network (or bus) 204. The processors 202 may be any type of processor such as a general purpose processor, a network processor (which may process data communicated over a computer network (102)), etc. (including a reduced instruction set computer (RISC) processor or a complex instruction set computer (CISC)). Moreover, the processors 202 may have a single or multiple core design. The processors 202 with a multiple core design may integrate different types of processor cores on the same integrated circuit (IC) die. Also, the processors 202 with a multiple core design may be implemented as symmetrical or asymmetrical multiprocessors.

The processor 202 may include one or more caches (203), which may be private and/or shared in various embodiments. Generally, a cache stores data corresponding to original data stored elsewhere or computed earlier. To reduce memory access latency, once data is stored in a cache, future use may be made by accessing a cached copy rather than refetching or recomputing the original data. The cache 203 may be any type of cache, such a level 1 (L1) cache, a level 2 (L2) cache, a level 3 (L-3), a mid-level cache, a last level cache (LLC), etc. to store electronic data (e.g., including instructions) that is utilized by one or more components of the system 200.

A chipset 206 may additionally be coupled to the interconnection network 204. The chipset 206 may include a memory control hub (MCH) 208. The MCH 208 may include a memory controller 210 that is coupled to a memory 212. The memory 212 may store data, e.g., including sequences of instructions that are executed by the processor 202, or any other device in communication with components of the computing system 200. In one embodiment of the invention, the memory 212 may include one or more volatile storage (or memory) devices such as random access memory (RAM), dynamic RAM (DRAM), synchronous DRAM (SDRAM), static RAM (SRAM), etc. Nonvolatile memory may also be utilized such as a hard disk. Additional devices may be coupled to the interconnection network 204, such as multiple processors and/or multiple system memories.

The MCH 208 may further include a graphics interface 214 coupled to a graphics accelerator 216. In one embodiment, the graphics interface 214 may be coupled to the graphics accelerator 216 via an accelerated graphics port (AGP). In an embodiment of the invention, a display device (such as a flat panel display) may be coupled to the graphics interface 214 through, for example, a signal converter that translates a digital representation of an image stored in a storage device such as video memory or system memory into display signals that are interpreted and displayed by the display. The display signals produced by the display device may pass through various control devices before being interpreted by and subsequently displayed on the display device.

As shown in FIG. 2, a hub interface 218 may couple the MCH 208 to an input/output control hub (ICH) 220. The ICH 220 may provide an interface to input/output (I/O) devices coupled to the computing system 200. The ICH 220 may be coupled to a bus 222 through a peripheral bridge (or controller) 224, such as a peripheral component interconnect (PCI) bridge, a universal serial bus (USB) controller, etc. The bridge 224 may provide a data path between the processor 202 and peripheral devices. Other types of topologies may be utilized. Also, multiple buses may be coupled to the ICH 220, e.g., through multiple bridges or controllers. For example, the bus 222 may comply with the PCI Local Bus Specification, Revision 3.0, Mar. 9, 2004, available from the PCI Special Interest Group, Portland, Oreg., U.S.A. (hereinafter referred to as a “PCI bus”). Alternatively, the bus 222 may comprise a bus that complies with the PCI-X Specification Rev. 2.0a, Apr. 23, 2003, (hereinafter referred to as a “PCI-X bus”), available from the aforesaid PCI Special Interest Group, Portland, Oreg., U.S.A. Alternatively, the bus 222 may comprise other types and configurations of bus systems. Moreover, other peripherals coupled to the ICH 220 may include, in various embodiments of the invention, integrated drive electronics (IDE) or small computer system interface (SCSI) hard drive(s), USB port(s), a keyboard, a mouse, parallel port(s), serial port(s), floppy disk drive(s), digital output support (e.g., digital video interface (DVI)), etc.

The bus 222 may be coupled to an audio device 226, one or more disk drive(s) 228, and a network adapter 230 (which may be a NIC in an embodiment). Other devices may be coupled to the bus 222. Also, various components (such as the network adapter 230) may be coupled to the MCH 208 in some embodiments of the invention. In addition, the processor 202 and the MCH 208 may be combined to form a single chip. Furthermore, the graphics accelerator 216 may be included within the MCH 208 in other embodiments of the invention.

Additionally, the computing system 200 may include volatile and/or nonvolatile memory (or storage). For example, nonvolatile memory may include one or more of the following: read-only memory (ROM), programmable ROM (PROM), erasable PROM (EPROM), electrically EPROM (EEPROM), a disk drive (e.g., 228), a floppy disk, a compact disk ROM (CD-ROM), a digital versatile disk (DVD), flash memory, a magneto-optical disk, or other types of nonvolatile machine-readable media capable of storing electronic data (e.g., including instructions).

The memory 212 may include one or more of the following in an embodiment: an operating system (O/S) 232, application 234, device driver 236, buffers 238, descriptors 240, and/or protocol driver 242. Programs and/or data stored in the memory 212 may be swapped into the disk drive 228 as part of memory management operations. The application(s) 234 may execute (e.g., on the processor(s) 202) to communicate one or more packets 246 with one or more computing devices coupled to the network 102 (such as the devices 104-114 of FIG. 1). In an embodiment, a packet may be a sequence of one or more symbols and/or values that may be encoded by one or more electrical signals transmitted from at least one sender to at least on receiver (e.g., over a network such as the network 102). For example, each packet 246 may have a header 246A that includes various information that may be utilized in routing and/or processing the packet 246, such as a source address, a destination address, packet type, etc. Each packet may also have a payload 246B that includes the raw data (or content) the packet is transferring between various computing devices (e.g., the devices 104-114 of FIG. 1) over a computer network (such as the network 102).

In an embodiment, the application 234 may utilize the O/S 232 to communicate with various components of the system 200, e.g., through the device driver 236. Hence, the device driver 236 may include network adapter (230) specific commands to provide a communication interface between the O/S 232 and the network adapter 230. For example, the device driver 236 may allocate one or more buffers (238A through 238M) to store packet data, such as the packet payload 246B. One or more descriptors (240A through 240M) may respectively point to the buffers 238. In an embodiment, one or more of the buffers 238 may be implemented as circular ring buffers. Also, one or more of the buffers 238 may correspond to contiguous memory pages in an embodiment. A protocol driver 242 may implement a protocol driver to process packets communicated over the network 102, according to one or more protocols.

In an embodiment, the O/S 232 may include a protocol stack that provides the protocol driver 242. A protocol stack generally refers to a set of procedures or programs that may be executed to process packets sent over a network (102), where the packets may conform to a specified protocol. For example, TCP/IP (Transport Control Protocol/Internet Protocol) packets may be processed using a TCP/IP stack. The device driver 236 may indicate the buffers 238 to the protocol driver 242 for processing, e.g., via the protocol stack. The protocol driver 242 may either copy the buffer content (238) to its own protocol buffer (not shown) or use the original buffer(s) (238) indicated by the device driver 236.

As illustrated in FIG. 2, the network adapter 230 may include a (network) protocol layer 250 for implementing the physical communication layer to send and receive network packets to and from remote devices over the network 102. The network 102 may include any type of computer network such as those discussed with reference to FIG. 1. The network adapter 230 may further include a direct memory access (DMA) engine 252, which writes packets to buffers (238) assigned to available descriptors (240) to transmit and/or receive data over the network 102. Additionally, the network adapter 230 may include a network adapter controller 254, which may include logic (such as a programmable processor) to perform adapter related operations. In an embodiment, the adapter controller 254 may be a MAC (media access control) component. The network adapter 230 may further include a memory 256, such as any type of volatile/nonvolatile memory (e.g., including one or more cache(s) and/or other memory types discussed with reference to memory 212).

In one embodiment, the network adapter 230 may include a locking logic 260 that may generate a signal that requests locking of one or more entries in an I/O TLB 262 that correspond to one or more memory access requests (e.g., including read or write accesses to the memory 212). The TLB 262 may be a content addressable memory (CAM) or other types of memory discussed with reference to memory 212. The logic 260 may be provided as part of the controller 254 in an embodiment. Moreover, the logic 260 may cause a memory access request (e.g., transmitted by the DMA engine 252) to include an indicia (e.g., that may be a one or more bits in various embodiments) to indicate that the corresponding entry in the I/O TLB 262 is to be locked. In an embodiment, a locked entry of the TLB 262 may be evicted after unlocked entries in the TLB 262 are evicted. In one embodiment, the DMA engine 252 may send the memory access request (with or without the locking indicia) to a virtualization logic 264. The logic 264 may determine based on one or more criterion whether or not the corresponding entry in the I/O TLB 262 is to be locked. Accordingly, the issuance of a locking request by the logic 260 may or may not result in the locking of a corresponding entry in the I/O TLB 262, for example, based on a determination by the virtualization logic 264. Additionally, the logics 260 and 264 may be provided in other locations than those shown in FIG. 2. For example, logic 260 may be provided in the chipset 206, e.g., within ICH 220 or MCH 208. Also, logic 264 may be located elsewhere within the chipset 206, e.g., provided outside of the MCH 208.

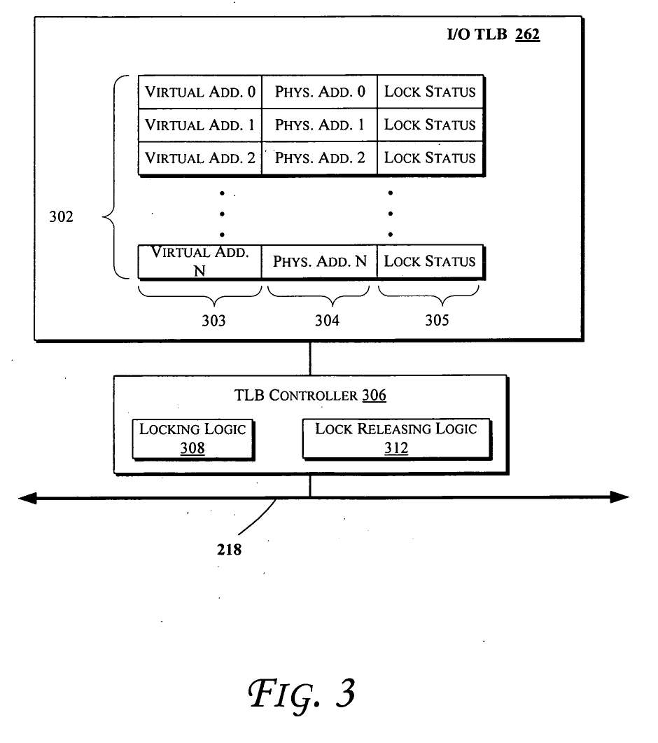

FIG. 3 illustrates a block diagram of portions of an input/output translation lookaside buffer (TLB) 262, according to an embodiment. In an embodiment, the TLB 262 may be the similar to or the same as the TLB 262 of FIG. 2. As shown in FIG. 3, the TLB 262 may include one or more entries 302. Each entry of the TLB 262 may have a virtual memory address field 303 (e.g., that stores the virtual memory address corresponding to a give entry), a physical memory address field 304 (e.g., that stores a physical memory address that corresponds to the virtual memory address of that TLB entry), and a lock status bit 305 (e.g., that may be utilized to indicate whether the corresponding TLB entry is locked).

In an embodiment, the TLB 262 may communicate with other components of the system 200 of FIG. 2 via a TLB controller 306. The TLB controller 306 may communicate with other components of the system 200 of FIG. 2 (e.g., the logic 252 and/or virtualization logic 264) via the hub interface 218. The controller 306 may include logic for various operations performed on the TLB 262. For example, the controller 306 may include a locking logic 308 (for example, to lock one or more of the lock bits 305, e.g., based on a signal generated by the virtualization logic 264) and/or a lock releasing logic 312 (e.g., to unlock one or more of the lock bits 305). Moreover, in an embodiment, a set bit 305 may indicate locking and a clear bit 305 may indicate no locking. However, alternatively, a set bit 305 may indicate no locking and a clear bit 305 may indicate locking. Hence, the logics 308 and 312 may set or clear bits 305 depending on implementation. Also, one or more of the logics 308 and/or 312 may be provided elsewhere in the system 200 of FIG. 2 (e.g., within the virtualization logic 264).

In an embodiment, the lock releasing logic 312 may unlock one or more bits 305 based on various criteria. For example, the lock releasing logic 312 may unlock one or more bits 305 based on: (1) a signal generated by the virtualization logic 264 to indicate that one or more specific TLB 262 entries are to be unlocked, (for example, based on available space in the TLB 262, e.g., when compared with a threshold level which may be configured via software or firmware, e.g., by a user), and/or (2) a cache replacement policy.

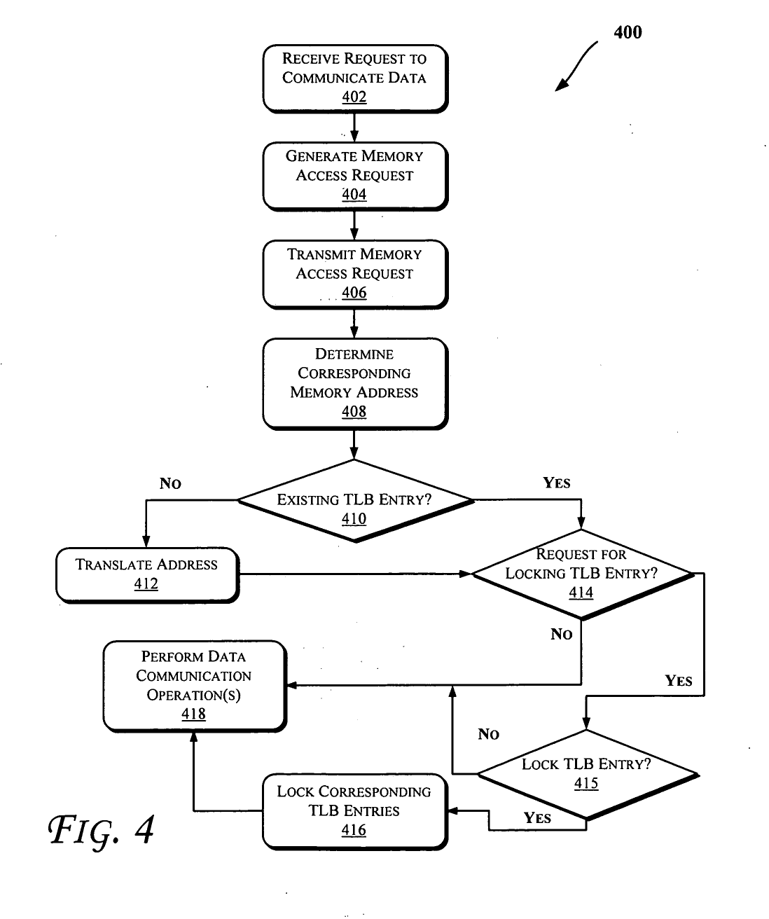

FIG. 4 illustrates a flow diagram of a method 400 to cause locking of one or more entries in a translation lookaside buffer, according to an embodiment. In an embodiment, various components discussed with reference to FIGS. 1-3 may be utilized to perform one or more of the operations discussed with reference to FIG. 4.

Referring to FIGS. 1-4, at an operation 402, the network adapter 230 may receive a request to communicate data (e.g., via the network 102). At an operation 404, the network adapter 230 may generate a memory access request to copy data to or from the memory 212, as discussed with reference to FIG. 2. In an embodiment, the locking logic 260 may cause the memory access request to include an indicia (such as a bit of data) to request that one or more corresponding entries in the TLB 262 be locked, as discussed with reference to FIGS. 2-3. The network adapter 230 may transmit the generated memory access request of operation 404 over the bus 222 to the MCH 208 at an operation 406.

At an operation 408, the virtualization logic 264 may determine the memory address corresponding to the transmitted memory access request of operation 406. In an embodiment, the transmitted memory access request may include a virtual memory address and the logic 264 may translate the virtual address into a corresponding physical address that corresponds to a portion of the memory 212 (such as a memory page). For instance, the logic 264 may access the TLB 262 to determine whether an entry corresponding to the virtual memory address exists in the TLB 262 at operation 410.

At an operation 412, if a corresponding entry is not present in the TLB 262, the logic 264 may access a page table (not shown), e.g., that may be stored in a storage unit discussed with reference to FIG. 2 such as the disk drive 228, to translate the virtual memory address of the memory access request into a physical memory address. After operations 410 and/or 412, at an operation 414, the virtualization logic 264 may determine whether the memory access request includes indicia to request locking of one or more of the corresponding TLB entries. If the memory access request includes an indicia to lock the corresponding entry (e.g., which may be a set or cleared bit transmitted with the memory access request in an embodiment), at an operation 415, the virtualization logic 264 may determine whether to lock the corresponding TLB entry based on various criteria such as available space in the TLB 262 (for example, when compared with a threshold level which may be configured via software or firmware, e.g., by a user), static and/or dynamic configuration (e.g., by a user and/or computing system), etc. Alternatively, the operation 414 may bypassed and the virtualization logic 264 may lock one or more of the TLB entries regardless of whether an indicia to a corresponding request to lock is present. For example, the logic 264 may cause locking of all TLB entries that correspond to addresses accessed by a given device (e.g., as long as the TLB 262 has available space for the new entries, or alternatively other TLB entries may be evicted to provide space for the new entries). In an embodiment, a locked entry of the TLB 262 may be evicted after unlocked entries in the TLB 262 are evicted.

At an operation 416, the locking logic 308 may lock the corresponding entry (e.g., by setting or clearing the corresponding locking bit 305). As discussed with response to FIG. 3, the logic 308 may lock the corresponding entry based on a signal generated by the virtualization logic 264. After operations 414, 415, and/or 416, at an operation 418, data communication operations may be performed to communicate data transmitted over the network 102, such as discussed with reference to FIG. 2.

In some embodiments, the components discussed with reference to FIGS. 2-4 may be provided and operations of method 400 may be performed without modifying the driver codes (such as the driver 236 or other driver codes for the chipset 206 and/or network adapter 230). Also, some of the embodiments may be applied for other types of memory accesses or transactions that target specific memory locations (e.g., memory pages) which may be reused more than once over time. Further, some embodiments may be applied to other I/O devices in a virtualized environment.

FIG. 5 illustrates a computing system 500 that is arranged in a point-to-point (PtP) configuration, according to an embodiment of the invention. In particular, FIG. 5 shows a system where processors, memory, and input/output devices are interconnected by a number of point-to-point interfaces. One or more of the devices 104-114 discussed with reference to FIG. 1 may include the system 500. Also, the operations discussed with reference to FIGS. 1-4 may be performed by one or more components of the system 500.

As illustrated in FIG. 5, the system 500 may include several processors, of which only two, processors 502 and 504 are shown for clarity. The processors 502 and 504 may each include a local memory controller hub (MCH) 506 and 508 to couple with memories 510 and 512. The memories 510 and/or 512 may store various data such as those discussed with reference to the memory 212 of FIG. 2. For example, each of the memories 510 and/or 512 may include one or more of the O/S 232, application 234, drivers 236 and 242, buffers 238, and/or descriptors 240.

The processors 502 and 504 may be any type of processor such as those discussed with reference to the processors 202 of FIG. 2. The processors 502 and 504 may exchange data via a point-to-point (PtP) interface 514 using PtP interface circuits 516 and 518, respectively. The processors 502 and 504 may each exchange data with a chipset 520 via individual PtP interfaces 522 and 524 using point to point interface circuits 526, 528, 530, and 532. The chipset 520 may also exchange data with a high-performance graphics circuit 534 via a high-performance graphics interface 536, using a PtP interface circuit 537.

Each of the processors 502 and 504 may include one or more processor cores 538 and 539, respectively. Also, at least one embodiment of the invention may be located within the processors 502 and 504. For example, the virtualization logic 264 and/or the TLB 262 may be located within the processors 502 and 504 (not shown). Other embodiments of the invention, however, may exist in other circuits, logic units, or devices within the system 500 of FIG. 5. For example, as illustrated in FIG. 5, the logic 264 and TLB 262 may be located within the chipset 520. Furthermore, other embodiments of the invention may be distributed throughout several circuits, logic units, or devices illustrated in FIG. 5.

The chipset 520 may be coupled to a bus 540 using a PtP interface circuit 541. The bus 540 may have one or more devices coupled to it, such as a bus bridge 542 and I/O devices 543. Via a bus 544, the bus bridge 543 may be coupled to other devices such as a keyboard/mouse 545, communication devices 546 (such as modems, network interface devices, etc.), an audio I/O device, and/or a data storage device 548. The data storage device 548 may store code 549 that may be executed by the processors 502 and/or 504. For example, the packet 246 discussed with reference to FIG. 2 may be transmitted to or received from the network 102 by the system 500 through the communication devices 546. The packet 246 may also be received through the I/O devices 543, or other devices coupled to the chipset 520. Furthermore, in some embodiments, one or more of the I/O devices 543, communication devices 546, and/or audio devices 547 may include the locking logic 260.

In various embodiments of the invention, the operations discussed herein, e.g., with reference to FIGS. 1-5, may be implemented by hardware (e.g., circuitry), software, firmware, microcode, or combinations thereof, which may be provided as a computer program product, e.g., including a machine-readable or computer-readable medium having stored thereon instructions (or software procedures) used to program a computer to perform a process discussed herein. Also, the term “logic” may include, by way of example, software, hardware, or combinations of software and hardware. The machine-readable medium may include a storage device such as those discussed with respect to FIGS. 1-5. Additionally, such computer-readable media may be downloaded as a computer program product, wherein the program may be transferred from a remote computer (e.g., a server) to a requesting computer (e.g., a client) by way of data signals embodied in a carrier wave or other propagation medium via a communication link (e.g., a bus, a modem, or a network connection). Accordingly, herein, a carrier wave shall be regarded as comprising a machine-readable medium.

Reference in the specification to “one embodiment” or “an embodiment” means that a particular feature, structure, or characteristic described in connection with the embodiment may be included in at least an implementation. The appearances of the phrase “in one embodiment” in various places in the specification may or may not be all referring to the same embodiment.

Also, in the description and claims, the terms “coupled” and “connected,” along with their derivatives, may be used. In some embodiments of the invention, “connected” may be used to indicate that two or more elements are in direct physical or electrical contact with each other. “Coupled” may mean that two or more elements are in direct physical or electrical contact. However, “coupled” may also mean that two or more elements may not be in direct contact with each other, but may still cooperate or interact with each other.

Thus, although embodiments of the invention have been described in language specific to structural features and/or methodological acts, it is to be understood that claimed subject matter may not be limited to the specific features or acts described. Rather, the specific features and acts are disclosed as sample forms of implementing the claimed subject matter.

What is claimed is:

1. An apparatus comprising:
a first logic to cause one or more input/output memory access requests to comprise an indicia to request that one or more corresponding entries in a translation lookaside buffer be locked; and
a second logic to transmit the memory access requests to a chipset.

2. The apparatus of claim 1, wherein the chipset comprises a third logic to determine, in response to the indicia, whether the one or more corresponding entries of the translation lookaside buffer are to be locked.

3. The apparatus of claim 1, wherein each entry of the translation lookaside buffer comprises one or more of: a virtual memory address, a physical memory address, and a locking bit.

4. The apparatus of claim 3, further comprising a third logic to cause the locking bit to be set or cleared.

5. The apparatus of claim 1, further comprising a memory to store data corresponding to the memory access requests.

6. The apparatus of claim 1, wherein the one or more memory access requests comprise one or more of a memory read access or a memory write access.

7. The apparatus of claim 1, wherein the indicia comprises one or more bits of data.

8. The apparatus of claim 1, further comprising a network adapter that comprises the first logic.

9. The apparatus of claim 1, wherein the chipset comprises the translation lookaside buffer.

10. The apparatus of claim 1, further comprising a third logic to cause a locked entry of the translation lookaside buffer to be evicted after unlocked entries in the translation lookaside buffer are evicted.

11. The apparatus of claim 1, further comprising a computer network to communicate one or more data packets corresponding to the one or more memory access requests.

12. A method comprising:
generating a memory access request that comprises an indicia to request that one or more corresponding entries in a translation lookaside buffer be locked; and
transmitting the memory access request to a chipset.

13. The method of claim 12, further comprising determining, in response to the indicia, whether the one or more corresponding entries of the translation lookaside buffer are to be locked.

14. The method of claim 12, further comprising locking the one or more corresponding entries by setting or clearing one or more corresponding bits in the translation lookaside buffer.

15. The method of claim 12, further comprising storing data corresponding to the memory access request in a memory.

16. The method of claim 12, further comprising evicting a locked entry of the translation lookaside buffer after unlocked entries in the translation lookaside buffer are evicted.

17. The method of claim 12, further comprising communicating one or more data packets corresponding to the memory access request over a computer network.

18. The method of claim 12, further comprising accessing the translation lookaside buffer to translate a virtual memory address corresponding to the memory access request into a physical memory address.

19. The method of claim 12, further comprising determining whether an entry corresponding to the memory access request is present in the translation lookaside buffer.

20. A computer-readable medium comprising one or more instructions that when executed on a processor configure the processor to:
receive a memory access request that comprises an indicia to request that one or more corresponding entries in a translation lookaside buffer be locked; and
determine, in response to the indicia, whether the one or more corresponding entries of the translation lookaside buffer are to be locked.

21. The computer-readable medium of claim 20, further comprising one or more instructions that configure the processor to determine whether the one or more corresponding entries of the translation lookaside buffer are to be locked based on a threshold level configured by a user.

22. The computer-readable medium of claim 20, further comprising one or more instructions that configure the processor to communicate one or more data packets corresponding to the memory access request over a computer network.

23. A system comprising:
a display device;
a network adapter coupled to the display device and configured to cause one or more input/output memory access requests to comprise an indicia to request that one or more corresponding entries in a cache be locked; and
a chipset coupled to the network adapter to determine whether the one or more corresponding entries of the cache are to be locked in response to the indicia.

24. The system of claim 23, wherein the display device comprises a flat panel display.

25. The system of claim 23, wherein the cache comprises a content addressable memory.
